(19) United States
(12) Patent Application Publication
(10) Pub. No.: US 2023/0408814 A1
(43) Pub. Date: Dec. 21, 2023

(54) HEAD UP DISPLAY SYSTEM

(71) Applicant: AGC GLASS EUROPE, Louvain-la-Neuve (BE)

(72) Inventors: Patrick AYOUB, Louvain-La-Neuve (BE); Nerio LUCCA, Fleurus (BE); Nicolas OU, Gosselies (BE); Jean-François NOULET, Grandmetz (BE); Soufiane EL ABDOUNI, Gosselies (BE)

(73) Assignee: AGC GLASS EUROPE, Louvain-la-Neuve (BE)

(21) Appl. No.: 18/250,666

(22) PCT Filed: Oct. 27, 2021
(86) PCT No.: PCT/EP2021/079829

§ 371 Date: Apr. 26, 2023

(30) Foreign Application Priority Data
Oct. 28, 2020 (EP) 20204504.3

(51) Int. Cl. G02B 27/01; G02B 5/30; G02B 1/08; G02B 27/00

(52) U.S. Cl. CPC G02B 27/0101; G02B 5/3083; G02B 1/08; G02B 27/0018; G02B 5/3066; G02B 2027/0196

(57) ABSTRACT

The present invention relates to a HUD system comprising a. a light source (14) projecting polarized light towards a glazing (10), said glazing (10) comprising an outer sheet of glass (11) having a first surface (P1) and a second surface (P2), and an inner sheet of glass (12) having a first surface (P3) and a second surface (P4), b. wherein over at least a portion of at least one of the surface (P1, P2, P3, P4) of the outer (11) and/or the inner sheet of glass (12) comprises a first enhanced p-polarized reflective coating (13). According to the present invention, the said light source (14) projecting polarized light comprises a waveplate (18) to compensate glass retardation in order to have P-polarized light at the outer face (P1) of the outer glass sheet (11).

### FIELD OF THE INVENTION

The present invention relates to head up display system, and to a method to provide for said head up display system.

### BACKGROUND OF THE INVENTION

Head up display systems, or HUD systems, are widely used in transportation devices to provide information on the vehicle glazing in the viewing area of a viewer or driver of said transportation device (also called HUD zone).

A wide variety of HUD systems are known. Commonly, a projection system is combined with a partial mirror (a partial reflector and partial window) as the final optical component for forming a projected image viewable by the user. Simultaneously, the user can view other scenes through the partial mirror. The partial mirror is an important component affecting the usability and perceived quality of the display. Generally, the reflectivity of the partial mirror must be sufficient to reflect light from the projector, but the partial mirror must also be sufficiently transparent to provide adequate viewing through it. In some embodiments, a linearly polarized light source is used along with a reflective layer that is preferentially reflecting the polarization of the light source.

One issue with conventional HUD systems results from the fact that many drivers wear polarized sunglasses to reduce glare from the road and other sources while driving. Typical polarized sunglasses work by blocking s-polarized radiation. P-polarized radiation is able to pass through the polarized sunglasses. However, in conventional HUD systems, s-polarized radiation is primarily what reflects off of the windshield to form the image of the HUD, and very little p-polarized radiation is reflected off of the windshield surfaces. This is especially true considering the windshield is typically positioned at an angle near the Brewster's angle for the air to glass interface. Thus, a driver wearing conventional polarized sunglasses may not be able to see the image of the HUD formed by the primarily s-polarized radiation.

Examples of HUD system are provided in CN104267498A for a head up display system comprising a projection light source, laminated glass and a transparent nanometer film, wherein the transparent nanometer film comprises at least one laminated structure of high reflective index layers/low reflective index layers which sediment sequentially outwards from the surface of an inner glass board; the projection light source is used for generating p-polarized light, the p-polarized light enters the transparent nanometer film, the reflectivity of the p-polarized light from the transparent nanometer film is not lower than 5%, and the incident angle of the p-polarized light ranges from 42 degrees to 72 degrees.

A further example of a HUD is provided in EP3187917A2 for a HUD system comprising a projection light source and a laminated glazing, the laminated glazing comprising an internal glass panel, an external glass panel and an intermediate film sandwiched between the internal glass panel and the external glass panel, wherein the head-up display system further comprises a transparent nanofilm comprising at least two dielectric layers and at least one metallic layer, each metallic layer being located between two dielectric layers; a difference between a refractive index of the intermediate film and a refractive index of the internal glass panel and the external glass panel is no more than 0.1; and the projection light source is used for generating p-polarized light which is incident on a surface of the internal glass panel away from the intermediate film, the light having an angle of incidence of 42 to 72 degrees, such that the transparent nanofilm can reflect part of the incident p-polarized light.

WO2019/046157A1 discloses laminate including: a first ply having a first surface and a second surface, where the first surface is an outer surface of the laminate; a second ply having a third surface facing the second surface and a fourth surface opposite the third surface, where the fourth surface is an inner surface of the laminate; an interlayer between the plies; and an enhanced p-polarized reflective coating positioned over at least a portion of a surface of the plies. When the laminate is contacted with radiation having p-polarized radiation at an angle of 60 relative to normal of the laminate, the laminate exhibits a LTA of at least 70% and a reflectivity of the p-polarized radiation of at least 10%. A display system and method of projecting an image in a heads-up display is also disclosed.

In addition to the issue of wearing polarized sunglasses, a typical issues with HUD systems is the appearance of a ghost image or a double image.

Particularly, the appearance of ghost image may be linked to the manufacturing process of a windshield.

More particularly, when a P-Polarized light is projected on a windshield for an HUD application, the glass stresses can affect the light polarization leading to creation of a parasitic S-polarization component. This parasitic S component can be seen as a ghost effect leading to poor quality image performance. The glass stresses are generated generally during a thermal treatment such as a heating and fast cooling of the glass for example during the bending process or the curing of the enamel commonly used onto a windshield.

Thus, the glass introduces delay, also called retardation or bi-refringence, on the light and particularly on the light projected from a HUD system projecting a P-polarization light.

There is therefore a need for an HUD system that compensate the glass retardation of p-polarized light projected onto the glazing and more particularly the windshield which can withstand thermal treatments and remains useful to reflect a clear and sharp image display on a glazing in a HUD system.

### SUMMARY OF THE INVENTION

The present invention provides a head up display (HUD) system that reflects light from the front windshield of a vehicle to be seen by the driver as a virtual image.

More particularly, the present invention provides the HUD system comprising
a. a light source projecting polarized light towards a glazing,
b. said glazing comprising an outer sheet of glass having a first surface and a second surface, and an inner sheet of glass having a first surface and a second surface,
wherein over at least a portion of at least one of the surface of the outer and/or the inner sheet of glass comprises a first enhanced p-polarized reflective coating, said both sheets being bonded by at least one sheet of interlayer material.

According to the present invention, the light source projecting polarized light comprises a waveplate to compensate glass retardation in order to have P-polarized light at the outer face of the outer glass sheet.

According to a preferred embodiment, a light source of the HUD system projects mainly a P-polarized light towards the glazing.

According to one embodiment of the present invention, the ratio of the intensity of the primary image intensity mainly P-pol light/ghost image intensity which can be composed of S and P-polarized light is higher than 15, more preferably higher than 20, more preferably higher than 50. The image is understood to be the image seen by the driver.

The system is configured to enable the driver to easily see the virtual image from the HUD without or with acceptable ghost image.

The present invention proposes a solution wherein an homogeneous retardation in reflection zone, also called the HUD zone, is obtained to avoid a ghost or double image when a P-polarized light from an HUD system is projected towards a glazing.

Today, the windshield are more and more complex in term of shape, involving a significant curvature. To reach the required shape of the windshield, the glass sheets are bent. The glass sheets are then submitted to a heating and fast cooling treatment leading generally to stresses into the glass sheets. The stresses are anisotropic through the glass sheets. The presence of stresses in the HUD area wherein a light source from a HUD projector is projected leads to an uneven retardation in the HUD area, leading to the appearance of an uneven ghost in the HUD image even if a HUD-P-polarized light projector is used.

The bent glass sheets lead to uncontrolled birefringence into the windshield and more particularly into the HUD zone.

One first step is to produce isotropic birefringence or delay by having homogeneous stress in the HUD zone. This is obtained by ensuring that the temperature is as uniform as possible in the area during the cooling stage of the process and particularly when going across the glass transition range (^{˜}580° C. to ^{˜}520° C.).

According to the present invention, the reduction or even the elimination of the ghost or double image may be obtained by using a light source that is polarized in order to obtain as pure as possible P-Polarized light at the glass-air interface in position 1 meaning the face of the glazing facing the exterior. In that case, the light beams have very low reflectance at that interface and most of the light seen by the observer is coming from P4 position leading to good quality picture. The goal of the present invention is to obtain a maximum of P-polarized light at glass-air interface of the glazing and more particularly on the outer face of the outer glass sheet (P1) close to Brewster angle.

The present invention may be applied to HUD system emitting a mix of S and P-polarized light as well as a HUD system emitting a P-polarized light only.

By “p-polarized light” it is meant that the light has an electric field along the plane of incidence. “Angle of incidence” is defined as the angle between a ray of radiation incident on a surface to a line normal to the surface at the point of incidence. The projector emits light directed at the windshield (laminate) such that the light contacts the windshield (laminate) at at least one point. By “s-polarized light” it is meant that the light has an electric field normal to the plane of incidence.

Also, the present invention may be used whatever the composition of the glass, the use of a wedge glazing or wedge interlayer, windshield comprising polarizer, coating configured, in a preferred embodiment, to P-polarized light.

Also provided is a method to provide for such a HUD system.

### BRIEF DESCRIPTION OF THE DRAWINGS

A better understanding of the present invention will be added upon reference to the following description in conjunction with the accompanying drawings.

FIG. 1 is a schematic side view of one embodiment of an automotive head up display arrangement of the present invention.

### DETAILED DESCRIPTION OF THE INVENTION

The present invention provides a head up display (HUD) system that reflects light from the front windshield of a vehicle to be seen by the driver as a virtual image.

More particularly, the present invention provides the HUD system comprising
a. a light source projecting polarized light towards a glazing,
b. said glazing comprising an outer sheet of glass having a first surface and a second surface, and an inner sheet of glass having a first surface and a second surface,
wherein over at least a portion of at least one of the surface of the outer and/or the inner sheet of glass comprises a first enhanced p-polarized reflective coating, said both sheets being bonded by at least one sheet of interlayer material.

According to the present invention, the light source projecting polarized light comprises a waveplate to compensate glass retardation in order to have P-polarized light at the outer face of the outer glass sheet. The outer face of the outer glass sheet is commonly known as face 1 or P1, with the inner face of the outer glass sheet is known as face 2 (or P2), the outer face of the inner glass sheet as face 3 or P3 and inner face of the inner glass sheet (the one directed towards the compartment of the car) as face 4 or P4.

According to one preferred embodiment of the present invention, a first enhanced p-polarized reflective coating is provided on at least a portion of the inner face of the inner glass sheet (also called face 4 or P4). More particularly, the HUD zone meaning the zone on the windshield wherein the image from the light source projecting polarized light is projected, is provided with the first enhanced p-polarized reflective coating. Thus, the reflection intensity is better and therefore more efficient.

According to a preferred embodiment, a light source of the HUD system projects mainly a P-polarized light towards the glazing.

The invention provides a HUD system that presents an acceptable image without requiring the use of a wedged windshield. Wedged windshields are designed to superimpose the image reflected from the front and back surface of the windshield to be seen by the driver. With the present invention, projected light reflects from the windshield to be seen by the driver as a virtual image, and mostly reflects from either the inside or outside surface of the windshield. Consequently, there is less need for a wedged windshield. It may be possible to use a windshield that is not wedged. In the embodiment in which the light reflects from the outside surface of the windshield, the light is polarized so the light from the virtual image is fully transmitted to a driver wearing conventional polarized sunglasses.

In one embodiment, the invention comprises a head up system for a motor vehicle, comprising a waveplate to compensate glass retardation provided between the windshield and the aspherical mirror, the aspherical mirror being a well-known part of an HUD system.

In the scope of the present invention, the light source provides preferably for p-polarized light. Such light allows for advantageous reflection of the projected information towards the driver/car passenger.

Typically, the projected light is incident to the glazing at an angle of 42 to 72 degrees. An advantage of the present HUD system configured with p-polarized light source, is that no or negligible double image is generated by the external glass surface (S1), if the incidence angle of light is close to the Brewster angle, typically around 56°, as a result of the effective p-polarized light reflectivity in the case of a coating dedicated to decrease the appearance of ghost image when a p-polarized light is emitted by a p-polarized HUD projector.

The glazing comprises an outer sheet of glass having a first surface (P1) and a second surface (P2), and an inner sheet of glass having a first surface (P3) and a second surface (P4). Such glazing is typically laminated. The outer sheet of glass of the glazing is that sheet in contact with the exterior of the vehicle or building. The inner sheet of glass is that sheet in contact with the inner space of the vehicle. The two sheets of glass are held in contact with a laminating sheet or interlayer, serving the adhesion and contact between the two sheets of glass. The interlayer provides for the contact between the first surface of the inner sheet of glass (P3) and the second surface of the outer sheet of glass (P2).

The glass may be a glass of soda-lime-silica, aluminosilicate or borosilicate type, and the like. Typically, the glass sheet is float glass, having a thickness of from 0.5 to 12 mm. In transportation applications, the glass may have a thickness ranging of from 1 to 8 mm, while they may also be thinner or thicker in construction applications, like ultrathin glass from 0.5 to 1 mm, or thicker glass, from 8 to 12 mm, in addition to the thickness of from 1 to 8 mm.

The composition of the glazing is not crucial for the purpose of the present invention, provided said glass sheet is appropriate for transportation or architectural applications. The glass may be clear glass, ultra-clear glass or colored glass, comprising one or more component (s)/colorant(s) in an appropriate amount as a function of the effect desired. Colored glass include grey, green or blue float glass. In some circumstances, colored glass may be advantageous to provide for appropriate and desired color of the final glazing.

The glass sheet may be flat or totally or partially curved to correctly fit with the particular design of the glass support, as the shape required for the application.

The interlayer typically contains thermoplastic materials, for example, polyvinyl butyral (PVB), ethylene vinyl acetate (EVA), polyurethane (PU), polyethylene terephthalate (PET), polycarbonate, or multiple layers thereof, typically with a total thickness of from 0.3 to −1.5 mm. The interlayer may contain colorants, and thus be a colored interlayer.

The interlayer typically has a uniform thickness throughout its surface between the two sheets of glass. The interlayer is thus typically not considered a “wedge” interlayer. A wedge interlayer may provide for artefacts in the reflected image, and is therefore not essential in the scope of the present invention. Further, such wedge interlayer is typically associated with additional cost for design and production.

In the scope of the present invention, the interlayer is typically free of light absorber or any light interfering polymers. In the scope of the present invention, the interlayer is typically not supporting a multilayer coating.

According to one embodiment of the present invention, the second surface of the inner sheet of glass (P4) comprises a first enhanced p-polarized reflective coating. The first coating comprises at least one layer of high refractive index material, and at least one layer of low refractive index material. In the scope of the present invention, such a sequence will be referred to as a “high/low” sequence.

In some embodiments, the first coating may comprise an alternation of layers high and low refractive indices, that is, the first coating may comprise more than one layer of high refractive index material, and/or more than one layer of low refractive index material. In such instances, the “high/low” sequence may occur more than once, that is, the sequence may be repeated at least 2 times. Repeat sequence of up to 3 or 4 or more times may be provided. In some instances, the repeating sequence will be no more than 3 times.

In the scope of the present invention, at least the inner sheet, provided with the first coating is suitable to withstand a thermal tempering process. Such inner sheet may thus be subject to a thermal tempering process.

In the scope of the present invention, a high refractive index is typically≥1.8, alternatively≥1.9, alternatively≥2.0, alternatively≥2.1, at a wavelength of 550 nm.

In the scope of the present invention, a low refractive index is typically <1.8, alternatively≤1.7, alternatively≤1.6, at a wavelength of 550 nm.

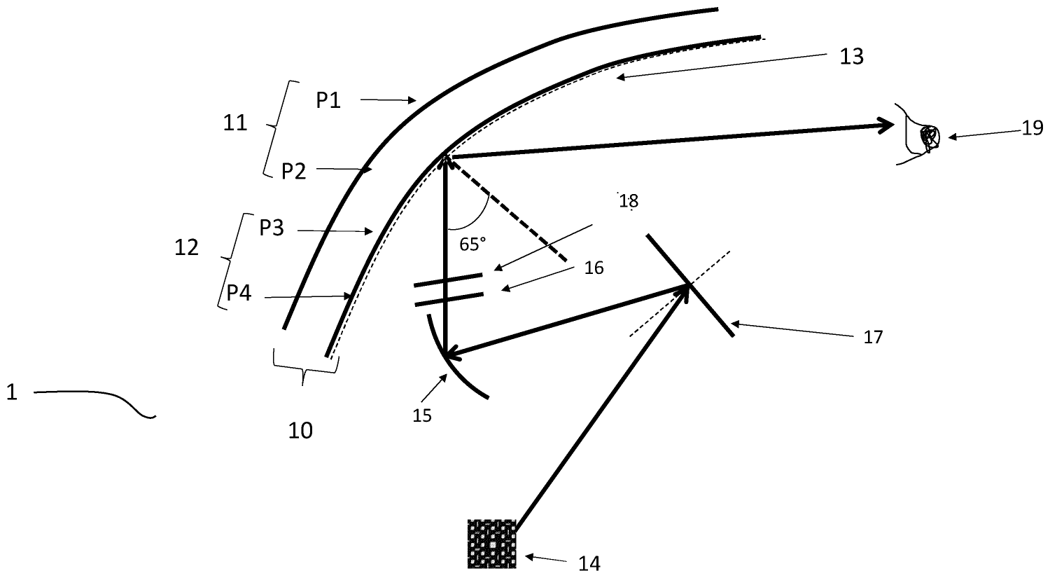

FIG. 1 illustrates one embodiment of an automotive head up display system 1 of the present invention, including a polarized HUD projector light source 14. A windshield 10 includes an outer glass sheet 11, an inner plastic (e.g., polyvinyl butyral (PVB)) layer (not shown), and an inner glass sheet 12. A first enhanced p-polarized reflective coating 13 is provided over all the inner surface P4 of the inner glass sheet 12. According to an embodiment of the present invention, the first coating comprises at least one layer of high refractive index material, and at least one layer of low refractive index material. In the scope of the present invention, such a sequence will be referred to as a “high/low” sequence. The head up display system 10 according to this embodiment, comprises a flat mirror 17 which reflects le light projected from the light source 14 to an aspherical mirror 15. A P-polarizer 16 is provided at the exit of the light from the aspherical mirror to 15 to have mainly P-polarized light projected towards the windshield 10. According to the present invention, a waveplate 18 is provided between the windshield and the aspherical mirror 15 and is oriented to maximize the proportion of p-polarization on external face of the outer glass sheet (P1). The waveplate 18 is provided to compensate glass retardation in order to have P-polarized light at the outer face of the outer glass sheet.

Since the light from the HUD projector is p-polarized in one embodiment, and is incident at Brewster's angle, there is no reflection from the outside surface of windshield 10. A waveplate 18, oriented as described above, allows to maximize the level of p-polarized light on the outer face of the outer glass sheet.

According to the present invention, the ratio of the intensity of the primary image intensity mainly P-pol light/ghost image intensity which can be composed of S and P-polarized light is higher than 15, more preferably higher than 20, more preferably higher than 50. The image is understood to be the image seen by the driver. Thus, ghost image is avoided and the quality of the reflected image is as required. The light from the source 14 which is incident on the outer surface of windshield 10 comprises s-polarized component even if the projector emits P-polarized light. The present invention allows to maximize the amount of P-polarized light on P1 even if the glass sheet comprises stresses and is anisotropic in the HUD-zone. Thus, the driver 19 sees one image with ghosting.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

An advantage of the present invention is that it solves the problem of variation of the birefringence in the HUD zone to avoid ghost image issues.

Another advantage of the present invention is that it makes it possible to implement a windshield HUD without a wedged windshield or any specific polarizer or specific interlayer.

The preset invention proposes also a method to provide to compensate glass retardation in order to have P-Polarized light at the outer face of the outer glass sheet, comprising the steps of:
a. Providing for a glazing by assembling a first sheet of glass, for at least one sheet of interlayer material, and for a second sheet of glass comprising a first enhanced p-polarized reflective coating
b. Providing for a light source capable of projecting a p-polarized light
c. Arranging said light source to project said p-polarized light towards said glazing at an incidence angle of 42 to 72°,
d. Providing a waveplate to compensate glass retardation in order to have P-polarized light at the outer face of the outer glass sheet, said waveplate being provided between the light source and the windshield.

In the scope of the present invention, the inner sheet of glass may be provided with a coating that may be subjected to a thermal treatment, given said first coating is able to withstand such thermal treatment. In some instances, the inner sheet of glass provided with the first coating is subjected to a thermal treatment.

The step of assembling the 2 sheets of glass and the at least one interlayer may be a lamination step for flat glass, or may be a bending step for curved laminated glass, which bending step includes the steps of first bending the sheets of glass and second, laminating said bent sheets of glass.

In some case, it may be useful to mechanically reinforce the outer glass sheet by a thermal treatment to improve its resistance to mechanical constraints. It may also be necessary to bend the vehicle glazing at high temperature for specific applications.

The thermal treatments comprise heating the glazing to a temperature of at least 560° C. in air, for example between 560° C. and 700° C., in particular around 640° C. to 670° C., during around 3, 4, 6, 8, 10, 12 or even 15 minutes according to the heat-treatment type and the thickness of the glazing. The treatment may comprise a rapid cooling step after the heating step, to introduce a stress difference between the surfaces and the core of the glass so that in case of impact, the so-called tempered glass sheet will break safely in small pieces. If the cooling step is less strong, the glass will then simply be heat-strengthened and in any case offer a better mechanical resistance.

The present glazing may be useful in transportation applications or architectural applications, where projection of images or light from a polarized light source (S or P or a mix of S and P) may be used. Architectural applications include displays, windows, doors, partitions, shower panels, and the like. In such architectural applications, the projection of a sharp image may be useful for displaying room or building information, or the like.

Transportation applications include those vehicles for transportation on road, in air, in and on water, in particular cars, busses, trains, ships, aircraft, spacecraft, space stations and other motor vehicles.

The present glazing may thus be a windshield, rear window, side windows, sun roof, panoramic roof or any other window useful for a car, or any glazing for any other transportation device, where the projection of a sharp image may be useful. The information projected and reflected may include any traffic information, such as directions or traffic density; or any vehicle status information, such as speed, temperature, or the like.

In some instances, the vehicle glazing may serve as a heatable vehicle glazing. Such heatable vehicle glazing includes heatable windshield.

In some embodiments, a second light source may be present in the HUD system and provide for a secondary image or information. The second light source may not be polarized or may be p-polarized or s-polarized, but would provide for an image the same or different from the first light source. In some instances, the image or information is different between the first and second light source. In some instances, augmented reality information may be projected by at least one of the light source.

When a second light source is present, the interlayer may be a wedge interlayer.

In the scope of the present invention, the presence of the first coating on a vehicle glazing allows for optimal light refection of a p-polarized light. The projected and reflected image will typically be sharp and clear, defined by a sharp contour and surface. Said surface is typically increased in case of blurred image due to the poor quality of the p-polarized light reflection of the glazing. The difference between a sharp and a blurred image contour is minimal, when the reflection property of the glazing is optimal.

The choice of materials for the first coating is critical to combine optical properties with heat and wear resistance, since the processing of such glazings typically involves bending and/or tempering coated glass at temperatures typically between 600 and 700° C. Further, the final utilization conditions involve that the coating is on the external surface of the glazing exposed to the interior of the vehicle or building, which implies exposure to various kind of cleaning agents, humidity, pollution and mechanical wear.

The present invention also provides for the use of a sheet of glass in a HUD system comprising a p-polarized light source which projects light at an angle of incidence on the glazing of 42 to 72°, to compensate glass retardation in order to have P-Polarized light at the outer face of the outer glass sheet.

Such glazing offers the advantage of optimally reflecting the p-polarized light when projected at an angle of incidence of 42 to 72°.

1. A head up display (HUD) system comprising
a. a light source (14) projecting polarized light towards a glazing (10),
b. said glazing (10) comprising an outer sheet of glass (11) having a first surface (P1) and a second surface (P2), and an inner sheet of glass (12) having a first surface (P3) and a second surface (P4),
wherein over at least a portion of at least one of the surface (P1, P2, P3, P4) of the outer (11) and/or the inner sheet of glass (12) comprises a first enhanced p-polarized reflective coating (13), said both sheets (11, 12) being bonded by at least one sheet of interlayer material,
characterized in that said light source (14) projecting polarized light comprises a waveplate (18) to compensate glass retardation in order to have P-polarized light at the outer face (P1) of the outer glass sheet (11).

2. The head up display (HUD) system (1) of claim 1, wherein the first enhanced p-polarized reflective coating (13) is provided on at least the HUD zone, of the inner face of the inner glass sheet, preferably, the HUD zone being the zone wherein the image for the light source is projected, preferably the enhanced p-polarized reflective coating (13) is provided over all the surface (P4) of the inner face of the inner glass sheet (12).

3. The head up display (HUD) system (1) of claim 1, wherein the glazing (10) is a windshield.

4. The head up display (HUD) system (1) of claim 1, wherein the light source (14) of the HUD system projects mainly a P-polarized light towards the glazing (10).

5. The head up display (HUD) system (1) of claim 1, wherein the ratio of the intensity of the primary image intensity mainly P-pol light/ghost image intensity which can be composed of S and P-polarized light is higher than 15, more preferably higher than more preferably higher than 50.

6. The head up display (HUD) system (1) of claim 1, wherein the light field has an electric field parallel to the plane of incidence (p-polarized).

7. The head up display (HUD) system (1) of claim 1, wherein the light field is incident to the windshield at approximately Brewster's angle.

8. The head up display (HUD) system (1) of claim 1, wherein the waveplate (18) is provided between the glazing (10) and the aspherical mirror (15) of the HUD light source (14).

9. The head up display (HUD) system (1) of claim 1, wherein the waveplate (18) is located on the exit of the light source (14).

10. The head up display (HUD) system (1) of claim 1, wherein the birefringence is homogeneous in the HUD zone leading to homogeneous delay in the HUD picture.

11. A method to compensate glass retardation in order to have P-Polarized light at the outer face of the outer glass sheet, comprising the steps of:
a. Providing for a glazing (10) by assembling a first sheet of glass (11), for at least one sheet of interlayer material, and for a second sheet of glass(12) comprising a first enhanced p-polarized reflective coating (13) over at least a portion of the surface (P1, P2, P3, P4) of the first (11) and/or the second (12)sheet of glass,
b. Providing for a light source (14) capable of projecting a p-polarized light
c. Arranging said light source (14) to project said p-polarized light towards said glazing (10) at an incidence angle of 42 to 72°,
d. Providing a waveplate (18) to compensate glass retardation in order to have P-polarized light at the outer face of the outer glass sheet, said waveplate being provided between the light source (14) and the glazing (10).

12. The method of claim 10 wherein the waveplate (18) is oriented to minimize reflected p-polarized light from the outer surface (P1) of the outer sheet of glass (11).

13. The method of claim 10, wherein the light field has an electric field parallel to the plane of incidence (p-polarized).
